(19) United States
(12) Patent Application Publication
(10) Pub. No.: US 2026/0192503 A1
(43) Pub. Date: Jul. 9, 2026

(54) METHODS OF MANUFACTURING A TEXTURED FABRIC

(71) Applicant: Veer Corporations Inc., Tomball, TX (US)

(72) Inventor: Harjeev SINGH, Ghandhinagar (IN)

(21) Appl. No.: 19/060,408

(22) Filed: Feb. 21, 2025

(30) Foreign Application Priority Data
Jan. 9, 2025 (IN) 202511002182

(51) Int. Cl. B29C 48/21; B29C 48/28; B29C 59/00; B29C 59/04; B29K 23/00

(52) U.S. Cl. CPC B29C 48/21; B29C 48/28; B29C 59/002; B29C 59/046; B29K 2023/12

(57) ABSTRACT

Methods of manufacturing a textured fabric that include coating a surface of fabric with a polymer and applying a texture to a surface of the fabric by feeding the fabric layer between a textured roller and a plain pressure roller. The textured roller can have an engraved pattern that imprints the texture onto the surface of the fabric.

### CROSS REFERENCE TO RELATED APPLICATIONS

This application claims the benefit of Indian Patent App. No. 202511002182, filed Jan. 9, 2025, the disclosure of which is hereby incorporated by reference herein.

### TECHNICAL FIELD

The present disclosure relates generally to methods of manufacturing textured fabric and more particularly to applying a textured design to fabrics, including coated fabrics.

### BACKGROUND

Coated fabrics can serve as protective barriers against water, wind, and other environmental factors. Conventional coated fabrics and products thereof often lack specialized surface treatments, limiting their performance in various applications. While several methods exist for applying surface designs, they often fall short in terms of precision, durability, and the ability to create complex patterns.

### SUMMARY

A method of manufacturing a textured fabric. The textured fabric comprises a fabric layer and a substrate layer. The method comprises coating a surface of the substrate layer with a polymer; while coating the surface of the substrate layer, applying a texture to a surface of the fabric layer by feeding the fabric layer between a textured roller and a plain pressure roller, and combining the substrate layer and the fabric layer into a textured fabric such that the coating of the polymer on the surface of the substrate layer is between the substrate layer and the fabric layer, and the textured surface of the fabric layer faces away from the substrate layer. The textured roller can have an engraved pattern that imprints the texture onto the surface of the fabric layer.

In certain aspects of the method, the polymer is heated while applying the texture; the temperature of the polymer is from about 170° C. to a maximum achievable temperature, e.g. about 320° C.; and/or the textured roller and the plain pressure roller apply a pressure of from about 75 psi to a maximum achievable pressure, e.g. about 95 psi, to the fabric layer.

In other aspects of the method, the coating of the surface of the substrate layer includes extruding the polymer onto the surface of the substrate layer; and/or the textured roller and the plain pressure roller are chilled, e.g. by a cooling backer roller. In an aspect, the textured roller and the plain pressure roller can be chilled to a temperature from about 12° C. to a maximum achievable temperature for cooling.

In an aspect, the method further comprises applying a printing material to the surface of the fabric layer after combining the substrate layer and the fabric layer.

In some aspects, the fabric layer is a spun bond non-woven fabric; the fabric layer has a width, and the texture is applied across an entirety of the width of the fabric layer; and/or the polymer comprises a mixture of polypropylene and at least one of a UV stabilizer, a dye, or a processing aid.

In an aspect, the method further comprises unwinding the substrate layer from a first payoff roll; unwinding the fabric layer from a second payoff roll; and winding the textured fabric into a wind-up roll.

A method of manufacturing a textured fabric that comprises coating a surface of a fabric with a polymer; and after the coating of the surface of the fabric, applying a texture to the surface of the fabric by feeding the fabric between a textured roller and a plain pressure roller. The textured roller can have an engraved pattern that imprints the texture onto the surface of the fabric. The textured roller and the plain pressure roller can be heated to apply heat to the fabric while applying the texture to the fabric.

In certain aspects of the method, the temperature of the textured roller and the plain pressure roller is from about 120° C. to about 140° C.; the textured roller and the plain pressure roller apply a pressure of from about 450 psi to a maximum achievable pressure, e.g. about 850 psi to the fabric; and/or the fabric moves through the textured roller and the plain pressure roller at a speed of from about 4 meters/minute to a maximum achievable speed, e.g. about 10 meters/minute.

In an aspect, the fabric can be a non-woven fabric, a laminated woven fabric, and/or a laminated non-woven fabric.

In another aspect, the fabric has a width, and the texture is applied across an entirety of the width of the fabric.

In an aspect, the method further comprises applying a printing material to the surface of the fabric after applying the texture to the surface of the fabric.

In yet another aspect, the method further comprises after coating the surface of the fabric with the polymer, winding the coated fabric into a payoff roll; unwinding the payoff roll before applying the texture to the surface of the fabric; and after applying the texture to the surface of the fabric, winding the textured fabric into a wind-up roll.

A method of manufacturing a textured fabric that comprises coating a surface of a fabric with a polymer; and after the coating of the surface of the fabric, applying a texture and a printing material to the surface of the fabric by applying a printing material to a textured roller and by feeding the fabric between the textured roller and a plain pressure roller. The textured roller can have an engraved pattern that imprints the texture onto the surface of the fabric and prints the printing material on the surface of the fabric.

In an aspect of the method, applying the printing material to the textured roller comprises transferring the printing material from an anilox roller to the textured roller, and the anilox roller is in fluid communication with a reservoir of the printing material.

In certain aspects of the method, the printing material comprises an ink or a dye; or the printing material comprises a UV cured ink.

In other aspects of the method, the textured roller and the plain pressure roller are heated to apply heat to the fabric while applying the texture to the fabric; a working temperature can be from about 25° C. plus due to hot air drying of the texture in the process; the fabric has a width, and the texture is applied across an entirety of the width of the fabric; and/or the fabric moves through the textured roller and the plain pressure roller at a speed of from about 20 meters/minute to a maximum achievable speed, e.g. about 70 meters/minute.

In some aspects of the method, the fabric is a non-woven fabric; and/or the polymer comprises a mixture of polypropylene and at least one of a UV stabilizer, a dye, and a processing aid.

In an aspect, the method further comprises after coating the surface of the fabric with the polymer, winding the coated fabric into a payoff roll; unwinding the coated fabric off of the payoff roll before applying the texture and the printing material to the surface of the fabric; and after applying the texture and the printing material to the surface of the fabric, winding the textured and printed fabric into a wind-up roll.

This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a schematic diagram illustrating an exemplary method of manufacturing a textured fabric, according to a first example of the present disclosure;

FIG. 2 is a flowchart of exemplary steps of the method of FIG. 1;

FIG. 3A is a view of an exemplary textured pattern of a textured fabric manufactured according to the method of FIG. 1;

FIG. 3B is an enlarged view of the textured pattern of FIG. 3A;

FIG. 4 is an enlarged partial cross-sectional view of a textured fabric manufactured according to the method of FIG. 1;

FIG. 5 is a schematic diagram illustrating an exemplary method of manufacturing a textured fabric, according to a second example of the present disclosure;

FIG. 6 is a flowchart of exemplary steps of the method of FIG. 5;

FIG. 7A is a view of an exemplary textured pattern of a textured fabric manufactured according to the method of FIG. 5;

FIG. 7B is an enlarged view of the textured pattern of FIG. 7A;

FIG. 8 is a schematic diagram illustrating an exemplary method of manufacturing a textured fabric, according to a third example of the present disclosure;

FIG. 9 is a flowchart of exemplary steps of the method of FIG. 8;

FIG. 10A is a view of an exemplary textured pattern of a textured fabric manufactured according to the method of FIG. 8; and

FIG. 10B is an enlarged view of the textured pattern of FIG. 10A.

### DETAILED DESCRIPTION

The present disclosure relates to methods of manufacturing textured fabric which can be used in various applications, such as synthetic building envelopes like roofing underlays, industrial bags, protective covers, building and pallet wraps, and the like. The methods of the present disclosure ensure a consistent and high-quality textured design that enhances the finished product's functional and aesthetic qualities. The methods of the present disclosure can provide intricate and durable surface patterns in the textured fabric that improve traction and visual appeal.

In a first example, the method comprises coating a surface of a substrate layer with a polymer; and while coating the surface of the substrate layer, applying a texture to a surface of a fabric layer by feeding the fabric layer between a textured roller and a plain pressure roller, wherein the textured roller has an engraved pattern that imprints the texture onto the surface of the fabric layer; and combining the substrate layer and the fabric layer into a textured fabric such that the coating of the polymer on the surface of the substrate layer is between the substrate layer and the fabric layer, and the textured surface of the fabric layer faces away from the substrate layer.

In a second example, the method of manufacturing a textured fabric comprises coating a surface of a fabric with a polymer; and after the coating of the surface of the fabric, applying a texture to the surface of the fabric by feeding the fabric between a textured roller and a plain pressure roller, wherein the textured roller can have an engraved pattern that imprints the texture onto the surface of the fabric, and wherein the textured roller and the plain pressure roller can be heated to apply heat to the fabric while applying the texture to the fabric.

In a third example, the method of manufacturing a textured fabric comprises coating a surface of a fabric with a polymer; and after the coating of the surface of the fabric, applying a texture and the printing material to the surface of the fabric by applying a printing material to a textured roller and feeding the fabric between the textured roller and a plain pressure roller. The textured roller can have an engraved pattern that imprints the texture onto the surface of the fabric and also prints the printing material on the surface of the fabric.

It is to be understood that the figures and descriptions of the present disclosure may have been simplified to illustrate elements that are relevant for a clear understanding of the present disclosure, while eliminating, for purposes of clarity, other elements found in a typical wearable assistance device or typical method of using a wearable assistance device. Those of ordinary skill in the art will recognize that other elements may be desirable and/or required in order to implement the present disclosure. However, because such elements are well known in the art, and because they do not facilitate a better understanding of the present disclosure, a discussion of such elements is not provided herein. It is also to be understood that the drawings included herewith only provide diagrammatic representations of the presently preferred structures of the present disclosure and that structures falling within the scope of the present disclosure may include structures different than those shown in the drawings. Reference will now be made to the drawings wherein like structures are provided with like reference designations.

Before explaining at least one embodiment in detail, it should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting.

It should further be understood that any one of the described features may be used separately or in combination with other features. Other invented devices, systems, methods, features, and advantages will be or become apparent to one with skill in the art upon examining the drawings and the detailed description herein. It is intended that all such additional devices, systems, methods, features, and advantages be protected by the accompanying claims.

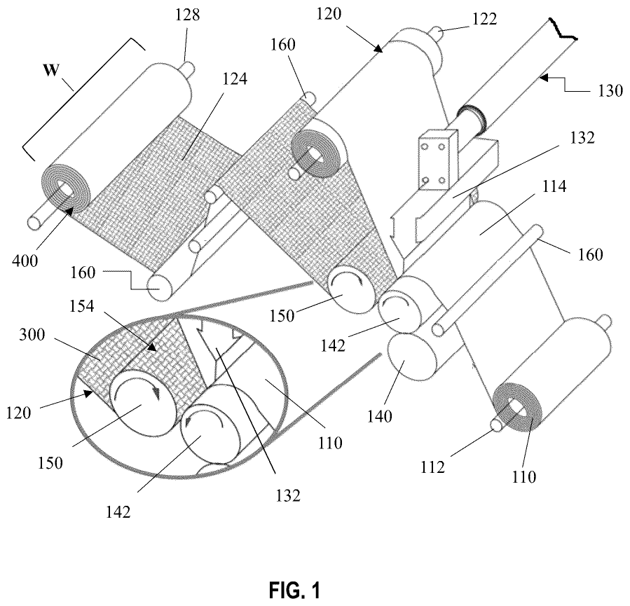

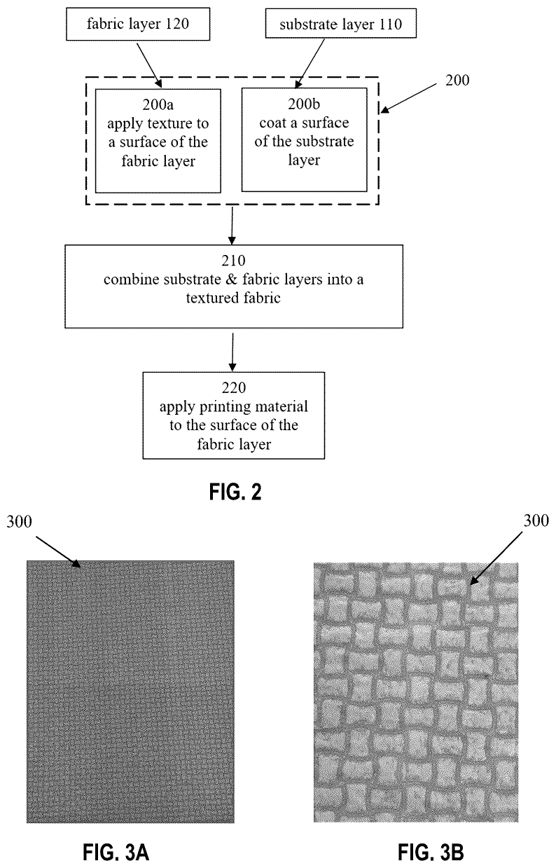

In this regard, FIG. 1 illustrates an exemplary method of manufacturing a textured fabric according to the first example and FIG. 2 is a flowchart of exemplary steps of the method of FIG. 1. In this example, the texturing of the fabric occurs at the coating stage, rather than after the coating stage. As seen in FIG. 1, a substrate layer 110 is provided that can be arranged in a roll which can be unwound from a first payoff roll 112, and a fabric layer 120 is provided, that can be arranged in a roll which can be unwound from a second payoff roll 122. The substrate layer 110 may be any woven fabric, for example. In an aspect, the substrate layer 110 is a polypropylene woven fabric. The fabric layer 120 may be any non-woven fabric, including spun bond non-woven fabrics which have optimal tensile strength and durability. In an aspect, the fabric layer 120 may be polypropylene non-woven fabric. The weight of the non-woven fabric can range from about 10 GSM (Grams per Square Meter) to a maximum achievable, e.g. 250 GSM, for example.

A coating stage 200 of the method incorporates a texturing process 200a into a coating process 200b, as seen in FIG. 2. The coating process 200b may begin with the preparation of material mixes, including polypropylene (PP), low density polyethylene (LDPE), antiskid additives, and master batches. These material components can be mixed and preheated for optimal consistency. For example, these material components can be heated to about 80° C. to a maximum achievable temperature. In an aspect, the coating material is a polymer comprising a mixture of polypropylene and at least one of a UV stabilizer, a dye, a processing aid, or additives.

The material mixture can be fed into an extruder 130 with temperature zones managed to optimize consistency, e.g. temperatures ranging from about 170° C. to a maximum achievable temperature, e.g. 320° C. Inside the extruder 130, the material mixture is melted and homogenized before being applied as a molten polymer coating or film to the substrate layer 110. The substrate layer 110 can be unwound from the first payoff roll 112 to be directed to the extruder 130, and particularly a precision die 132 thereof. The molten polymer can be applied or extruded to a surface 114 of the substrate layer 110 using the precision die 132 of the extruder 130 at a controlled pressure, such as about 75 psi to 85 psi, to ensure uniform thickness and adhesion of the coating to the surface 114. The molten polymer can be forced, for example, through a slot in the precision die 132 to a form a thin continuous film or coating on the surface 114 of the substrate layer 110. This film can be applied directly onto the moving substrate layer 110. The coated substrate layer 110 can optionally undergo a corona treatment to improve surface adhesion for subsequent polymer layers.

During the coating stage 200, a texture 300 (also referred to as a textured pattern or design) can be applied to the fabric layer 120 via the texturing process 200a. The texturing process 200a may comprise feeding the fabric layer 120 between a textured roller 150 and the plain pressure roller 142, as seen in FIG. 1, to create a consistent texture on the fabric layer 120. The fabric layer 110 can be unwound from the second payoff roll 122 and the substrate layer 110 continues unwinding from the first payoff roll 112 and the polymer coating can be applied between the substrate layer 110 and the fabric layer 120 while the layers are fed between the rollers 142 and 150. While the texture is being applied to the fabric layer 120, the polymer for the coating can be maintained an optimal temperature from about 170° C. to a maximum achievable temperature, e.g. 320° C. The unwinding of the fabric layer 120 from the second payoff roll 122 can be synchronized with the unwinding of the substrate layer 110 from the first payoff roll 112.

The textured roller 150 can have an engraved pattern or design 154 that imprints the desired texture 300 onto a surface 124 of the fabric layer 120 The textured roller 150 can be made of steel, for example. The plain pressure roller 142 presses the fabric layer 120 firmly against the textured roller 150, enhancing the precision of the imprinted design. FIG. 3A is a view of an example of the texture or textured pattern 300 that can result from this texturing process and FIG. 3B shows an enlarged view of the textured pattern 300 of FIG. 3A.

The textured roller 150 and the plain pressure roller 142 can be heated to heat the fabric layer 120 while applying the texture to the fabric layer 120 and optimize processing. The textured roller 150 and the plain pressure roller 142 can be chilled, e.g. by a cooling backer roller 140, as seen in FIG. 1. In an aspect, the textured roller 150 and the plain pressure roller 142 can be chilled to a temperature from about 12° C. to a maximum achievable temperature for cooling. The textured roller 150 and the plain pressure roller 142 can be configured to imprint the desired texture 300 across the entire width W of the fabric layer 120, ensuring consistent pattern quality. The textured roller 150 and the plain pressure roller 142 can apply a pressure to optimize texture imprinting on the fabric layer 120. For example, the textured roller 150 and the plain pressure roller 142 can operate at a pressure of from about 85 psi to a maximum achievable pressure, e.g. about 95 psi. The pressure from the rollers 150 and 142 imprint the pattern onto the fabric while the polymer coating remains heated. This creates a raised or recessed design on the fabric, adding texture and depth. Texturing can be used to create various patterns, such as geometric shapes, leather-like textures, custom designs or the like.

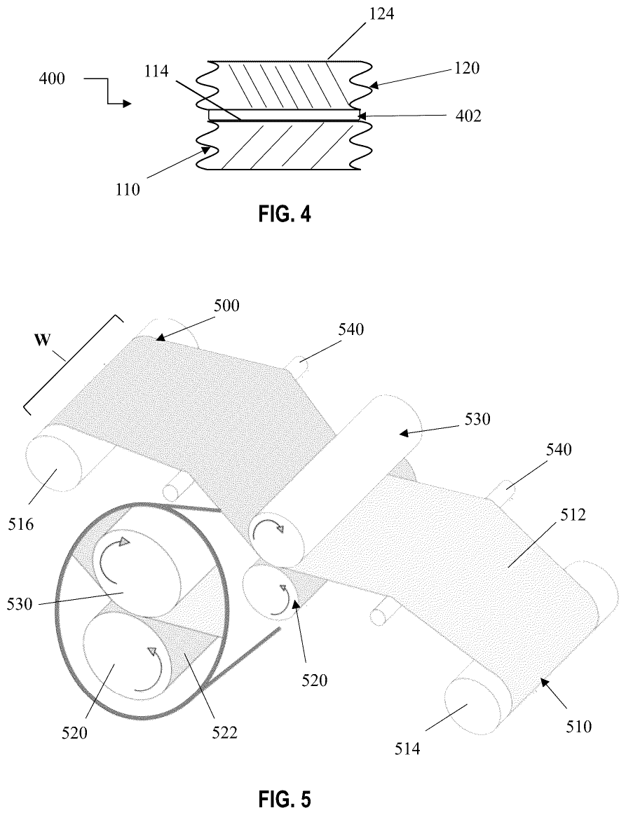

After the coating stage 200 (including the texturing of the fabric layer 120), the substrate layer 110 and the fabric layer 120 can be combined (step 210 of FIG. 2) into a textured fabric 400. As seen FIG. 4, which shows a cross-sectional view of the textured fabric 400, the coating of polymer 402 on the surface 114 of the substrate layer 110 can be between the substrate layer 110 and the fabric layer 120, and the textured surface 124 of the fabric layer 120 can face away from the substrate layer 110.

One or more guide rolls 160 may also be employed to facilitate the movement of the substrate and fabric layers 110 and 120 through the coating and texturing stage and ultimately the winding of the textured fabric 400 on a wind-up roll 128. All of the rollers can be configured to maintain synchronization between the fabrics's unwind and rewind rolls, allowing for steady fabric movement and consistent texturing throughout the process.

The textured surface of the texture fabric 400 manufactured according to this method improves grip and usability. The textured patterns can enhance the textured fabric's visual design aesthetic appeal of the textured fabric product. The method ensures a final textured fabric product that meets certain requirements, such as for adhesion, durability, and surface finish.

The coating stage 200, including the texturing process 200a and the coating process 200b, is configured to ensure the fabric is adequately prepared for optimal performance in subsequent stages. For example, after combining the substrate layer 110 and the fabric layer 120 (step 210 of FIG. 2), a printing material can be applied to the surface of the fabric layer 120 (step 220 of FIG. 2). The resulting uniform texture 300 of the textured fabric 400 not only enhances the aesthetic appeal but also serves as an optimized base for high-quality printing on the fabric's surface. Printing can add intricate designs and patterns to the textured fabric.

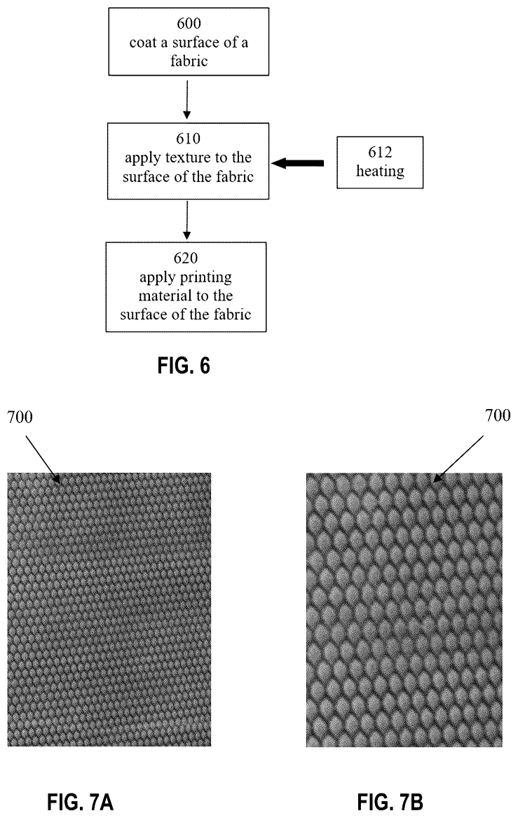

FIG. 5 illustrates an exemplary method of manufacturing a textured fabric according to the second example and FIG. 6 is a flowchart of exemplary steps of the method of FIG. 5. In this second example, the texturing of the fabric occurs after the coating stage and before the printing stage. This method generally comprises coating a surface 512 of a fabric 510 with a polymer (step 600 of FIG. 6). The fabric 510 may be any woven or non-woven fabric, or any laminated woven or laminated non-woven fabric. For example, the fabric 510 can be a polypropylene laminated woven fabric or an unlaminated non-woven fabric. The fabric 510 can be coated using an extruder similar to the first example above, or by other known coating methods. The coated fabric 510 can then be textured. That is, after the coating of the surface 512 of the fabric 510, a texture 700 (FIGS. 7A and 7B) can be applied to the surface 512 of the fabric 510 by feeding the fabric 510 between a textured roller 520 and a plain pressure roller 530 to form the textured fabric 500 (step 610 of FIG. 6). Similar to the first example, the textured roller 520 has an engraved pattern 522 that imprints the texture 700 onto the surface of the fabric. FIG. 7A is a view of an example of the texture or textured pattern 700 of the textured fabric 500 that can result from this method and FIG. 7B shows an enlarged view of the textured pattern 700 of FIG. 7A.

In an aspect, the coated fabric 510 can be unwound from a payoff roll 514 and fed between the textured roller 520 and the plain pressure roller 530. After the texture 700 is applied to the coated fabric 510, the resulting textured fabric 500 can be wound onto a wind-up roll 516.

Heat can be applied to the textured roller 520 and the plain pressure roller 530 (step 612 of FIG. 6) to apply heat to the fabric while applying the texture to the fabric (step 610 of FIG. 6). The heat can be applied via hot air drying, for example, that results in a working temperature of about 25° C. plus. The pressure and heat from the rollers imprint the pattern onto the fabric. In an aspect, the textured roller 520 can be uniformly heated to imprint the desired texture across the entire width W of the fabric 510, ensuring consistent txture pattern quality. In an aspect, the textured roller 520 is oil-heated. The textured roller 520 and the plain pressure roller 530 can operate at a speed to optimize processing of the fabric. For example, the textured roller 520 and the plain pressure roller 530 can operate at a speed of about 4 to 10 meter/minute. The pressure applied to the fabric by the textured roller 520 and the plain pressure roller 530 can be managed to optimize texture imprinting onto the fabric 510. For example, the textured roller 520 and the plain pressure roller 530 can operate at a pressure of about 450 psi to a maximum achievable pressure, e.g. about 850 psi. The temperatures of the textured roller 520 and the plain pressure roller 530 can also be managed to optize imprinting and processing of the farbic 120. For example, the textured roller 520 and the plain pressure roller 530 can operate at temperatures between about 120° C. to a maximum achievable temperature, e.g. about 140° C., to imprint the desired design onto the fabric's surface.

One or more guide rolls 540 may also be employed to facilitate the movement of the fabric 510 through the texturing stage and ultimately the winding of the textured fabric 500 on the wind-up roll 516. All of the rollers can be configured to maintain synchronization between the fabric's unwind and rewind rolls, allowing for steady fabric movement and consistent texturing throughout the process.

The texturing and heating at steps 610 and 612 are configured to ensure the fabric is adequately prepared for optimal performance in subsequent stages. For example, after step 610, a printing material can be applied to the surface 512 of the fabric 510 (step 620 of FIG. 6). The resulting uniform texture 700 of the textured fabric 500 not only enhances the aesthetic appeal but also serves as an optimized base for high-quality printing on the fabric's surface, such as for adding designs and patterns to the textured fabric.

The method of the second example allows for wide-width heat press texturing after coating. This enhances both efficiency and design flexibility, such as the following: uniform texturing across large surfaces of the fabric due to consistent pressure and heat distribution, allowing for seamless patterns and textures across wide-width materials; increased production efficiency because by accommodating larger widths, this method significantly reduces processing time, making it ideal for high-volume production in industries like textiles, flooring, and packaging; design versatility because wide-width texturing of the method enables intricate and large-scale patterns, expanding creative possibilities for new designs and manufacturing capabilities; enhanced material performance because the method adds functional benefits, such as drainage efficiency, improved grip, reduced slippage, or added durability, tailored for specific applications like residential, commercial and industrial textiles, membranes, and upholstery; and customization capability because the method offers the flexibility to switch between designs or textures quickly, catering to diverse customer requirements without extensive downtime and wastage.

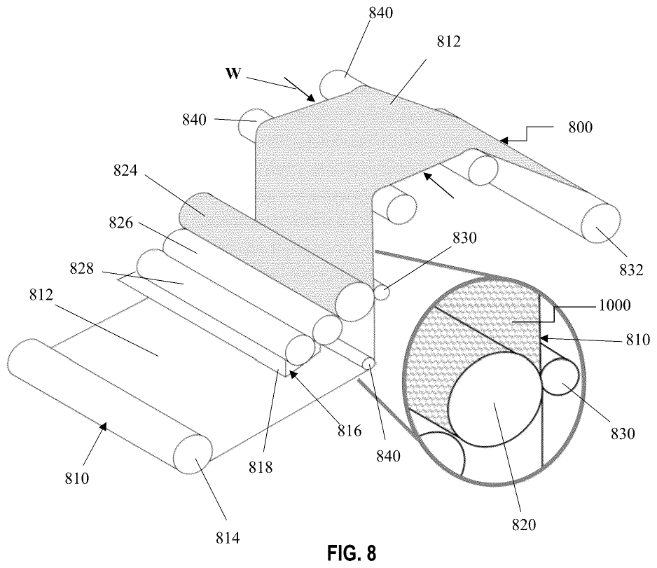

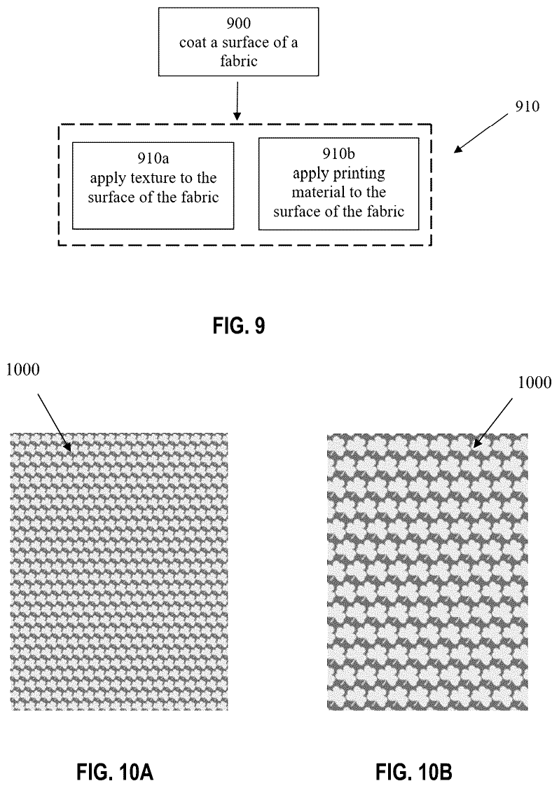

FIG. 8 illustrates an exemplary method of manufacturing a textured fabric according to the third example and FIG. 9 is a flowchart of exemplary steps of the method of FIG. 8. In this third example, the texturing of the fabric occurs after the coating stage and during the printing stage (rather than before the printing stage as in the second example). That is, the texturing of the fabric is incorporated into the printing process of the fabric. This method generally comprises the steps of coating a surface 812 of a fabric 810 with a polymer (step 900 of FIG. 9), and after coating the surface 812 of the fabric 810, applying a texture and a printing material to the surface 812 of the fabric 810 (step 910 of FIG. 9). The fabric 810 can be coated using an extruder similar to the first example above, or by other known coating methods.

Step 910 includes a texturing process 910a and a printing process 910b applied together to the fabric surface 812. The combined texturing and printing processes 910a and 910b can be used to apply various designs, patterns, graphics, logos, and the like, directly onto the coated fabric 810. The texturing process 910a combined with the printing stage 900 integrates patterns, designs, and colors into the coated fabric 810, enhancing both aesthetic appeal and functional properties. This can be accomplished by applying a printing material 816 to a textured roller 820 and feeding the fabric 810 between the textured roller 820 and a plain pressure roller 830. Similar to the above examples, the textured roller 820 has an engraved pattern 824 that imprints a texture 1000 onto the surface 812 of the fabric 810 while also printing the printing material 816 on the surface 812 of the fabric 810.

Similar to the above examples, the textured roller 820 transfers the desired texture or pattern 1000 onto the fabric 810 through controlled pressure and heat, ensuring accurate replication of the design. The textured roller 820 and the plain pressure roller 830 can be tension controlled to ensure that the coated fabric 810 has consistent contact with the textured roller 820 when fed into the printing stage 900.

The method may include the step of inspecting the coated fabric 810 for surface uniformity before feeding the coated fabric 810 into the printing stage 900. Any inconsistencies in the coating can be corrected prior to texturing and printing to ensure optimal texturing.

As with the above examples, the fabric 810 may be any woven or non-woven fabric. The fabric 810 can be coated using an extruder similar to the first example above, or by other known coating methods. The printing material 816 may be, for example, high-quality inks chosen to ensure excellent adhesion, vibrancy, and long-lasting texture effects. UV-cured inks can provide superior durability in harsh conditions.

FIG. 10A is a view of an example of the texture or textured pattern 1000 of the textured fabric 800 that can result from this method and FIG. 10B shows an enlarged view of the textured pattern 1000 of FIG. 10A. The texture 1000 imprinted on the surface 812 of the coated fabric 810 can be, for example, simple geometric patterns or complex organic motifs or designs tailored to specific customer requirements. Base colors and patterns can be integrated into the texturing process using compatible printing materials, such as inks and dyes. The choice of ink, e.g. water-based, solvent-based, or UV-cured, can be selected to suit the fabric material and intended use. For multi-dimensional effects, layering of colors and textures can be achieved through repeated passes of the fabric 810 through the printing stage 900.

The textured roller 820 and the plain pressure roller 830 can operate at a speed that optimizes the processing of the fabric 810. For example, the rollers 820 and 830 can operate at a speed of about 30 to 70 meter/minute to match the texture complexity and ensure a smooth, uninterrupted process. Also, the temperature of the rollers 820 and 830 can be managed to optimize the processing of the fabric 810. For example, heating zones can be maintained at a temperature ranging from about 25° C. to 80° C. For example, a working temperature may be from about 25°C. plus due to in process hot air drying during imprint of the desired texture 1000 across the entire width W of the fabric 810, ensuring consistent pattern quality.

One or more guide rolls 840 may also be employed to facilitate the movement of the coated fabric 810 through the printing stage 900 and ultimately the winding of the processed textured fabric 800 on a wind-up roll 832. All of the rollers can be configured to maintain synchronization between the fabric's unwind and rewind rolls, allowing for steady fabric movement and consistent texturing throughout the process.

An anilox roller 826 can be used to transfer a desired amount of the printing material 816 to the textured roller 820, which then applies the printing material 816 to the fabric. As seen in FIG. 1, the anilox roller 826 can be positioned adjacent to the textured roller 820. The anilox roller 826 can have a surface covered with small, engraved cells which hold and release a controlled volume of the printing material 816. The anilox roller 826 can be in fluid communication with a reservoir 818 of the printing material 816 (e.g. ink or dye) to pick up the printing material 816 from the reservoir 818 and transfer the printing material 816 to the textured roller 820. The reservoir 818 may be positioned below the anilox roller 826. A fountain roller 828 can optionally be used in conjunction with the anilox roller 826 to facilitate transfer of the printing material 816 from the reservoir 818 to the anilox roller 826.

The method may further comprise a quality control check of the fabric 810 post-texturing and printing processes 910a and 910b. That is, after the printing stage 900, the fabric 810 can undergo quality checks for colourfastness, texture integrity, and adhesion strength.

The above methods of the present disclosure may include the preliminary steps of manufacturing the woven or non-woven fabric layers before texturing. For example, the methods may include the step of granules to tape manufacturing to convert raw materials into tapes (to be woven together) through extrusion and stretching. This may begin with the preparation of raw materials, such as polypropylene (PP) granules, fillers, UV stabilizers, and master batches. These material components can undergo quality control checks to ensure compliance with predefined standards for optimal performance. Once cleared, the material components can be mixed and preheated to a temperature of approximately 80° C. a maximum achievable temperature to ensure uniformity. The prepared mixture can be fed into an extruder, where barrel temperatures are controlled, typically ranging from 250° C. to a maximum achievable temperature, e.g. 300° C., depending on the formulation of the mixture. The extruder processes the mixture into a homogenous molten state. The molten material is then directed through a T-die at elevated temperatures of approximately 270° C. to a maximum achievable temperature, e.g. about 310° C. to produce a continuous, uniform film with consistent thickness.

The extruded film can then enter a quenching stage, where it is rapidly cooled and solidified in a water bath maintained at 30° C. to a maximum achievable temperature, e.g. about 40° C. This step ensures the material stabilizes quickly, retaining its shape and dimensional integrity. Post-quenching, the film can be split into tapes using precision cutting equipment. Adjustable spacers on the cutters allow control over the tape width, ensuring uniform dimensions. This assists with maintaining consistency throughout subsequent production stages.

The slit tapes undergo a stretching process, facilitated by a series of godets and hot air ovens. The stretching ratio, e.g. between 5.0 to 8.0, can be adjusted according to the desired tape width and denier (thickness). This process enhances the mechanical properties of the tapes, including tensile strength and elongation.

After stretching, the tapes can be subjected to an annealing process. In this stage, the tapes are heated to temperatures ranging from 140° C. to a maximum achievable temperature to relieve internal stresses and enhance dimensional stability. The annealing temperature is carefully controlled to remain below the stretching temperature (usually 80° C. to a maximum achievable temperature), preventing any degradation of material properties. During annealing, precise temperature control and duration are critical. The molecular structure of the material relaxes effectively, and stress-induced deformations are minimized. Following this, the tapes are gradually cooled to room temperature, which prevents sudden contractions or distortions. Gradual cooling ensures that the properties improved during annealing are preserved.

Once cooled, the tapes can be wound onto bobbins, ensuring proper alignment and tension. Each bobbin is labelled with identification markers for traceability, aiding quality assurance and inventory management. The finalized tapes are now ready for downstream applications or additional processing.

The tapes next go through a weaving process to form a woven fabric. This can begin with feeding the stretched and annealed tapes into precision weaving machines. These machines are calibrated to produce fabric rolls with consistent dimensions and specifications. The weaving process can be designed to achieve fabric rolls with, for example, a minimum width of 38 inches to 157 inches, and a pick count tailored to application requirements, which can vary in the range of 5×5 to 12×12. The tapes can be interlaced in the warp and weft directions using controlled loom mechanisms to ensure uniform fabric construction.

The loom speed of the weaving machines may be at 400 to a maximum achievable revolutions per minute (rpm), balancing productivity and fabric quality. The tension in the warp and weft tapes can be controlled to prevent stretching or slack during weaving, which could compromise the fabric's strength and uniformity.

After weaving, the fabric rolls can be systematically labelled for traceability and quality management. The labelled fabric rolls can then be inspected for quality assurance and stored for dispatch or further processing, ensuring that the final product meets the required specifications.

The methods of the present disclosure may also include the step of manufacturing the non-woven fabric. For example, the methods may include forming of non-woven fabric from raw materials. This process can begin with polypropylene (PP) granules, mixed with proprietary mix of additives such as UV stabilizers, colour masterbatches, and processing aids. These raw materials can undergo a quality control process to ensure compliance with predefined standards. The granules are melted in an extruder at controlled temperatures ranging, e.g. between 250° C. and a maximum achievable temperature, creating a homogenous molten polymer blend.

The molten material can then be forced through a spinneret to form fine, continuous fibers. These fibers are rapidly cooled using air quenching to solidify them into the desired thickness and consistency. The solidified fibers are laid into a uniform web through high-speed conveyor systems, using air or mechanical laydown techniques to ensure consistent layering. The web is then passed through thermal bonding rollers, where heat and pressure are applied to fuse the fibres at contact points. This bonding enhances the tensile strength, durability, and uniformity of the fabric.

The bonded non-woven fabric can then be rolled onto large spools, ready for downstream applications. These nonwoven fabric rolls can be produced in a wide range of weights, from 10 GSM to a maximum achievable weight, e.g. about 250 GSM, catering to various thicknesses and performance needs, such as filtration, packaging, or construction applications. The rolls can be inspected for quality, ensuring uniformity and adherence to performance standards before dispatch or further processing.

The textured fabrics manufactured according to the methods of the present disclosure can have various applications in various industries due to the textured fabrics'durability, flexibility, along with the precise application of surface patterns, which enhance the product's functional performance and aesthetic properties.

Example applications include building and construction, namely roofing underlayment which provides a slip-resistant, weatherproof base under roofing materials, building wraps, which acts as a breathable barrier for energy efficiency and moisture control in walls, flashing tapes, which ensures airtight and watertight seals around openings like windows and doors, and/or vapor barriers, which prevent moisture migration in foundations, crawl spaces, and other critical areas.

The texturing of the textured fabric enhances roofing fabrics, for example, in a number of ways such as by improving grip and traction, enhancing water resistance, increasing durability, enhancing the visual appeal of a roof, additional thermal insulation, and noise reduction for a quieter indoor environment.

Another application of the texture fabrics may be packing, namely heavy-duty bags, such as those used for industrial storage and transportation, including agricultural and construction materials, and/or protective covers, which offers tear resistance and weatherproofing for items like furniture, vehicles, and machinery.

The textured fabrics of the present disclosure may also can application in agriculture, namely ground covers that are used to control weeds and soil erosion while allowing water permeability, or greenhouse liners that provide thermal insulation and light reflection for better plant growth.

Industrial applications may include geomembranes, which provide waterproofing and containment in landfill liners, ponds, and mining operations, automotive covers used in vehicle manufacturing for seat covers, floor mats, and protective wrappings; or insulation layers which serves as a barrier in industrial insulation systems.

The textured fabrics of the present disclosure may be used in consumer products, such as outdoor fabrics that create weather-resistant tarpaulins, tents, and awnings, or sports and recreational gear like that applied in equipment such as backpacks, kites, and inflatables for added durability. The texture fabrics of the present disclosure can also have application in medical and hygiene products, such as disposable protective covers that are used in hospitals for covering beds, instruments, and surfaces, or sanitary products that are incorporated into diapers and adult incontinence products for liquid containment.

Logistics and transportation applications of the textured fabric of the present disclosure may include cargo liners that provide protection and weatherproofing for goods during shipping, or pallet wrapping that secures goods for stability and protection in warehouses and transit.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

As used in this specification and the appended claims, the singular forms “a”, “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

Additionally, where a method described above or a method claim below does not explicitly require an order to be followed by its steps or an order is otherwise not required based on the description or claim language, it is not intended that any particular order be inferred. Likewise, where a method claim below does not explicitly recite a step mentioned in the description above, it should not be assumed that the step is required by the claim.

It is noted that the description and claims may use geometric or relational terms. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

What is claimed is:

1. A method of manufacturing a textured fabric, the textured fabric comprising a fabric layer and a substrate layer, the method comprising:
coating a surface of the substrate layer with a polymer;
while coating the surface of the substrate layer, applying a texture to a surface of the fabric layer by feeding the fabric layer between a textured roller and a plain pressure roller, the textured roller having an engraved pattern that imprints the texture onto the surface of the fabric layer; and
combining the substrate layer and the fabric layer into a textured fabric such that the coating of the polymer on the surface of the substrate layer is between the substrate layer and the fabric layer, and the textured surface of the fabric layer faces away from the substrate layer.

2. The method of claim 1, wherein the polymer is heated when applying the texture.

3. The method of claim 1, wherein the textured roller and the plain pressure roller apply a pressure of from about 75 psi to about 95 psi to the fabric layer.

4. The method of claim 1, wherein coating the surface of the substrate layer includes extruding the polymer onto the surface of the substrate layer.

5. The method of claim 1, wherein the textured roller and the plain pressure roller are chilled by a cooling backer roller.

6. The method of claim 1, further comprising, after combining the substrate layer and the fabric layer, applying a printing material to the surface of the fabric layer.

7. The method of claim 1, further comprising:
unwinding the substrate layer from a first payoff roll;
unwinding the fabric layer from a second payoff roll; and
winding the textured fabric into a wind-up roll.

8. The method of claim 1, wherein the fabric layer has a width, and the texture is applied across an entirety of the width of the fabric layer.

9. The method of claim 1, wherein the polymer comprises a mixture of polypropylene and at least one of a UV stabilizer, a dye, or a processing aid.

10. A method of manufacturing a textured fabric, the method comprising:
coating a surface of a fabric with a polymer; and
after the coating of the surface of the fabric, applying a texture to the surface of the fabric by feeding the fabric between a textured roller and a plain pressure roller, the textured roller having an engraved pattern that imprints the texture onto the surface of the fabric,
wherein the textured roller and the plain pressure roller are heated to apply heat to the fabric while applying the texture to the fabric.

11. The method of claim 10, wherein the temperature of the textured roller and the plain pressure roller is from about 120°C. to about 140°C., and the textured roller and the plain pressure roller apply a pressure of from about 450 psi to about 850 psi to the fabric.

12. The method of claim 10, wherein the fabric has a width, and the texture is applied across an entirety of the width of the fabric.

13. The method of claim 10, further comprising, after applying the texture to the surface of the fabric, applying a printing material to the surface of the fabric.

14. The method of claim 10, further comprising:
after coating the surface of the fabric with the polymer, winding the coated fabric into a payoff roll;
unwinding the payoff roll before applying the texture to the surface of the fabric; and
after applying the texture to the surface of the fabric, winding the textured fabric into a wind-up roll.

15. A method of manufacturing a textured fabric, the method comprising:
coating a surface of a fabric with a polymer; and
after the coating of the surface of the fabric, applying a texture and a printing material to the surface of the fabric by applying the printing material to a textured roller and by feeding the fabric between the textured roller and a plain pressure roller, the textured roller having an engraved pattern that imprints the texture onto the surface of the fabric and prints the printing material on the surface of the fabric.

16. The method of claim 15, wherein applying the printing material to the textured roller comprises transferring the printing material from an anilox roller to the textured roller, the anilox roller being in fluid communication with a reservoir of the printing material.

17. The method of claim 15, wherein the textured roller and the plain pressure roller are heated to apply heat to the fabric while applying the texture to the fabric.

18. The method of claim 15, wherein the fabric has a width, and the texture is applied across an entirety of the width of the fabric.

19. The method of claim 15, further comprising:
after coating the surface of the fabric with the polymer, winding the coated fabric into a payoff roll;
unwinding the coated fabric off of the payoff roll before applying the texture and the printing material to the surface of the fabric; and
after applying the texture and the printing material to the surface of the fabric, winding the textured and printed fabric into a wind-up roll.

20. The method of claim 15, wherein the polymer comprises a mixture of polypropylene and at least one of a UV stabilizer, a dye, and a processing aid.
